(19) United States
(12) Patent Application Publication
(10) Pub. No.: US 2013/0192543 A1
(43) Pub. Date: Aug. 1, 2013

(54) Device for Introducing Biomaterial into a Combustion or Carburetor Chamber

(71) Applicant: Claus Hinterecker, Vienna (AT)

(72) Inventor: Claus Hinterecker, Vienna (AT)

(73) Assignees: Clara Panning, Vienna (AT); Armin Faltl, Vienna (AT); RAW HOLDING GMBH, Vienna (AT); Christian Raunegger, Vienna (AT); Claus Hinterecker, Vienna (AT)

(21) Appl. No.: 13/824,004

(22) PCT Filed: Sep. 9, 2011
(86) PCT No.: PCT/AT11/00368

§ 371 Date: Mar. 29, 2013

(30) Foreign Application Priority Data
Sep. 17, 2010 (AT) A 1553/2010

(51) Int. Cl. F02B 43/08

(52) U.S. Cl. CPC F02B 43/08
USPC 123/3

(57) ABSTRACT

The invention relates to a device for introducing biomaterial into a pressure-loaded combustion or carburetor chamber (1), comprising a feed apparatus (2) for feeding biomaterial to a pressure pipe (3), in which a plunger (4) is guided in such a way that the plunger can be moved back and forth against a pressure lock (5) to the combustion or carburetor chamber (1) in order to form a compressed plug (6) comprised of biomaterial, which is sealed against the combustion chamber (1) and which is periodically advanced toward the combustion chamber (1).

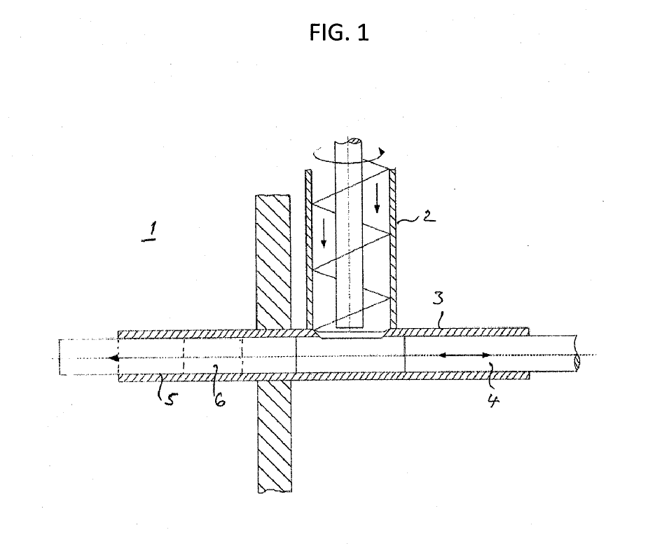

The invention relates to a device for introducing biomaterial into a pressure-loaded combustion or carburetor chamber.

Currently known are the following methods for introducing a predominantly solid fuel of biogenic and non-biogenic origin, or a combination of such fuels, in a combustion or carburetor chamber for power, heat and cold production:
Rotary star valves
Pressure swing locks
Press, plug, or compacting screw

Biogenic fuels could involve wood chippings or shavings, saw dust, leaves, grass cuttings, straw, chopped waste from forestry and agriculture, pressing residues, as well as, for example, waste cooking oil as liquid additive.

Non-biogenic fuels could involve shredded plastic materials, waste, rubber, but also liquid additives of, for example, mineral oil residues or sewage sludge.

The well-known prior art has several disadvantages.

Rotary star valves have to be worked very precisely to provide an effective sluice function. When the gliding surfaces are abraded or warped because of the impact of heat, these devices quickly lose tightness. Rotary star valves are expensive, can be used only with low pressure differences and are subject to high level of wear and loss of function. Furthermore, it is of disadvantage that each subdivision ejects during the process of re-loaded its pressure volume from the combustion chamber, which pressure volume is subject to the combustion chamber pressure after the fuel has been dispensed into the combustion chamber.

Pressure swing locks, whether used separately or coupled with a rotary star valve, have similar disadvantages of recurring pressure discharge from the system and are also subject to a high level of wear, especially on the sealing surfaces as a result of abrasion or heat impact. The systems are expensive and require high maintenance. Especially when exposed to higher pressures and higher temperatures, they do not provide any effective technical seal against the atmospheric ambience.

Press, plug, or compacting screws operate according to the principle of a tapered helical mount, in which fuel compression and thus a pressure lock function is achieved. Often such systems have the design of a cone snail. These systems have the disadvantage that excessive friction results in the fact that the fuel to be transported gets stuck in the helical mount, thus inhibiting the transport function. The system has to be shut down and the helical mount has to be cleaned in a complicated manual process. Because of the danger of breaking, plug screws are often manufactured from expensive, forged material and can be used effectively only with low pressure differences.

The invention has the objective of providing a pressure carburetor device of the type mentioned at the outset which is able to prevent the above-mentioned disadvantages.

The invention-based device is characterized by a pressure pipe provided with a feed device for biomaterial. Said pressure pipe is provided with a plunger which can be moved back and forth and which seals the combustion and carburetor chamber against a pressure lock by forming a compressed plug consisting of biomaterial, which seals the combustion chamber, preferably by way of hydrolyses resulting in consolidation and compacting of the biomaterial, and which is periodically pushed forward toward the combustion chamber.

Therefore, the invention is based on the compression of biomaterial by means of a plunger in a pressure pipe. Because of the resulting wall reveal of the material in the pressure pipe such high resistance is caused that the fuel plug developing against the internal pressure forms an effective lock toward the atmospheric ambience. The plunger moves axially back and forth inside the pressure pipe and discharges with each stroke new biomaterial into the pressure pipe, highly compressing said biomaterial and moving the resulting fuel plug forward.

Because of the friction and highly adiabatic compression of the introduced biomaterial, the biomaterial is homogenized and, due to the chemical aggressiveness of the hot water vapor, which results from the residual moisture, the biomaterial is hydrolyzed at the surface which, for example, in the case of cellulose, releases sugar molecules which, in turn, cause the material to stick together. The resulting compressed plug seals the opening to the combustion or carburetor chamber and can thus be used as a pressure lock.

Preferably, with each stroke of plunger, a pellet of biomaterial is formed which moves the previously formed compressed plug pellet forward.

According to a further characteristic of the invention, the plunger in the pressure pipe can be operated with a frequency of up to 600 strokes/min and applied with a load of up to 300 t.

However, the plunger can also operate with 1-10 forward movements per second, preferably with load impact which can range between a few kg (for example, a hammer) and several tons (hydraulics), depending on the dimensions of the system and the design of the plunger.

Subsequently, the invention is described in more detail by means of an embodiment with reference to a drawing in which the device is shown in a sectional diagram.

The device is arranged in a pressure carburetor chamber (not shown), which is generally depicted with numeral 1 and which is exposed to a pressure of between 30 and 5 bar. However, if required, it can be operated also with considerably higher pressure of, for example, 150 bar. By heating the gases in the combustion or carburetor chamber 1 to temperatures of between 200 and 1600° C., all interfering compounds, for example, long-chained tar compounds, resulting from the gasification process are cracked open.

An essential characteristic of the pressure carburetor is that it uses pure oxygen for the gasification process. This increases significantly its effectiveness because it is not necessary to withdraw thermal energy from the system by heating useless atmospheric nitrogen.

Another essential characteristic of the pressure carburetor is represented by an integrated heat recovery, in which the water used for cooling is turned into superheated steam and then completely into synthesis gas, filtered and subsequently condensed under pressure.

In the invention-based pressure carburetor, the bio-fuel is introduced into the pressure pipe 3 by means of a feed device 2, which is able to withstand high temperatures and is provided with a cooling device (not shown). In the pressure pipe 3, which is tapered at the outlet end to its combustion or carburetor chamber 1, or can be designed with grooves, a plunger 4, which is periodically propelled by a drive device (not shown), can be moved back and forth with a frequency of up to 600 strokes/min. and a load stroke of up to 300 t. In a pressure lock 5 of the pressure pipe 3, the plunger 4 compresses the introduced biomaterial, resulting in a compressed plug 6 in the form of a pellet of biomaterial which is successively moved forward into the combustion or carburetor chamber 1. At the same time, the compressed plug 6 has the purpose of sealing the pressure pipe 3 toward the combustion or carburetor chamber 1.

As a result, the invention provides a simple, safe and cost-effective device for progressively introducing the compressed biomaterial into the combustion or carburetor chamber. Because of the pressurization, the compressed biomaterial is homogenized, which can result in consolidation and compacting of the material. The plunger can have the design of a hydraulic ram or a gas pressure punch. The drive system can also be designed as a mechanical pressure screw press, an electro-pressure cylinder, a hammer or a ram crankshaft flywheel system.

An expert realizes that in the context of the inventive idea the embodiment described can be modified in different ways, especially with regard to the feed device and the drive system of the plunger.

1. Device for introducing biomaterial into a pressure-loaded combustion or carburetor chamber (1), characterized by a pressure pipe (3) provided with a feed device (2) for biomaterial, which pressure pipe (3) is provided with a plunger which can be moved back and forth and which seals the combustion and carburetor chamber against a pressure lock by forming a compressed plug consisting of biomaterial, which seals the combustion chamber, preferably by way of hydrolyses resulting in consolidation and compacting of the biomaterial, and which is periodically pushed forward toward the combustion chamber.

2. The device according to claim 1, characterized in that the biomaterial is formed into pellets which are successively moved forward by means of the plunger (4) into the combustion or carburetor chamber (1).

3. The device according to claim 1, characterized in that the pressure pipe (3) consists of a material that is able to withstand high temperatures and/or that is provided with a cooling device which preferably is tapered designed with grooves at the outlet end.

4. The device according to claim 1, characterized in that the plunger (4) in the pressure pipe (3) can be operated with a frequency of up to 600 strokes/min.

5. The device according to claim 1, characterized in that the plunger (4) can be applied with a load of up to 300 t.
